(19) United States
(12) Patent Application Publication
(10) Pub. No.: US 2017/0192957 A1
(43) Pub. Date: Jul. 6, 2017

(54) METHODS AND ANALYTICS SYSTEMS HAVING AN ONTOLOGY-GUIDED GRAPHICAL USER INTERFACE FOR ANALYTICS MODELS

(71) Applicant: International Business Machines Corporation, Armonk, NY (US)

(72) Inventors: Tsuyoshi Ide, Harrison, NY (US); Jayant Kalagnanam, Tarrytown, NY (US); Young M Lee, Old Westbury, NY (US); Nizar Lethif, Croton-on-Hudson, NY (US); Naihui Song, New York, NY (US)

(21) Appl. No.: 14/983,629

(22) Filed: Dec. 30, 2015

(51) Int. Cl. G06F 17/27; G06F 17/22; G06F 3/0482; G06F 3/0484; G06F 17/18

(52) U.S. Cl. CPC G06F 17/2785; G06F 3/04842; G06F 17/18; G06F 3/0482; G06F 17/2235; G06F 17/2264; G06F 17/2205

(57) ABSTRACT

Embodiments include methods, and computer program products of an ontology-guided analytics graphical user interface (GUI). Aspects include: linking the ontology-guided graphical user interface for analytics models to an ontology based analytics solution library, receiving a definition of a management project to be solved by the analytics system from a user via the ontology-guided graphical user interface for analytics models, selecting, by the user via the ontology-guided graphical user interface for analytics models, a solution from the ontology based analytics solution library according to the management project, building one or more workflows to solve the management project, and executing the workflows to generate solution to management project. Building may include generating workflows of modeling tasks for analytics selected as an actionable widget. Executing may include a representational state transfer (REST)-based wrapper service including data store services module, execution services module, analytics services module, visualization services module, and data transformation services module.

### BACKGROUND

The present disclosure relates generally to resource and operations management, and more particularly to methods, systems and computer program products of an analytics system having an ontology-guided graphical user interface for analytics models.

Analytics is a multidimensional discipline. There is extensive use of mathematics and statistics, the use of descriptive techniques and predictive models to gain valuable knowledge from data—data analysis. The insights from data are used to recommend action or to guide decision making rooted in business context. Thus, analytics is not so much concerned with individual analyses or analysis steps, but with the entire methodology.

There are many types of analytics that can solve various problems in industry in the areas of resource and operations management, but it is often difficult for common users who don't have in-depth knowledge of analytics available to select appropriate analytics for solving a specific problem, develop and run the analytics in appropriate steps and manners to produce desired results. It is desirable to have a user interface that enable the common users without specialized training in mathematical modeling to identify, develop, and use analytics to solve complex industrial problems in resource and operations management.

Therefore, heretofore unaddressed needs still exist in the art to address the aforementioned deficiencies and inadequacies.

### SUMMARY

In an embodiment of the present invention, a method of an analytics system having an ontology-guided graphical user interface for analytics models may include: linking the ontology-guided graphical user interface for analytics models to an ontology based analytics solution library, receiving a definition of a management project to be solved by the analytics system from a user via the ontology-guided graphical user interface for analytics models, selecting, by the user via the ontology-guided graphical user interface for analytics models, a solution from the ontology based analytics solution library according to the management project, building one or more workflows to solve the management project, and executing the workflows to generate solution to the management project. In certain embodiments, the building may include generating the workflows of modeling tasks for the analytics selected as an actionable widget. The executing may include a representational state transfer (REST)-based wrapper service. In exemplary embodiments, the REST-based wrapper service may include: providing a uniform interface for storing input data and retrieving output data via a data store services module, providing a generic execution environment for the algorithm selected via an execution services module, implementing the algorithm selected via an analytics services module, providing a variety of visualizations for input and output data on a visualization device via a visualization services module, and providing a variety of schematic and structural transformations for input data and output data via a data transformation services module.

In another embodiment of the present invention, an analytics system may include a computer. The computer may include a processor to operate an ontology-guided graphical user interface for analytics models, and a memory storing computer executable instructions for the ontology-guided graphical user interface for analytics models of the analytics system. When the computer executable instructions are executed at the processor, the computer executable instructions cause the analytics system to perform: linking the ontology-guided graphical user interface for analytics models to an ontology based analytics solution library, receiving a definition of a management project to be solved by the analytics system from a user via the ontology-guided graphical user interface for analytics models, selecting, by the user via the ontology-guided graphical user interface for analytics models, a solution from the ontology based analytics solution library according to the management project, building one or more workflows to solve the management project, and executing the workflows to generate solution to the management project. In certain embodiments, the building may include generating the workflows of modeling tasks for the analytics selected as an actionable widget.

In yet another embodiment of the present invention, the present disclosure relates to a non-transitory computer storage medium. In certain embodiments, the non-transitory computer storage medium stores computer executable instructions. When these computer executable instructions are executed by a processor of an analytics system having an ontology-guided graphical user interface for analytics models, these computer executable instructions cause the analytics system to perform: linking the ontology-guided graphical user interface for analytics models to an ontology based analytics solution library, receiving a definition of a management project to be solved by the analytics system from a user via the ontology-guided graphical user interface for analytics models, selecting, by the user via the ontology-guided graphical user interface for analytics models, a solution from the ontology based analytics solution library according to the management project, building one or more workflows to solve the management project, and executing the workflows to generate solution to the management project. In certain embodiments, the building may include generating the workflows of modeling tasks for the analytics selected as an actionable widget.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a block diagram illustrating an exemplary processing system of an analytics system having an ontology-guided analytics graphical user interface according to certain embodiments of the present invention;

FIG. 2 is an exemplary ontology hierarchy of assets management for the ontology-guided graphical user interface for analytics models according to certain embodiments of the present invention;

FIG. 3 is an exemplary smarter resource and operation management (SROM) industry solution library for the ontology-guided graphical user interface for analytics models according to certain embodiments of the present invention;

FIG. 4 is a block diagram illustrating an exemplary ontology-guided graphical user interface for analytics models according to certain embodiments of the present invention; and

FIG. 5 is a flow chart of an exemplary method of the ontology-guided graphical user interface for analytics models of the analytics system according to certain embodiments of the present invention.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way. Consequently, alternative language and synonyms may be used for any one or more of the terms discussed herein, nor is any special significance to be placed upon whether or not a term is elaborated or discussed herein. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “plurality” means two or more. The terms “comprising,” “including,” “carrying,” “having,” “containing,” “involving,” and the like are to be understood to be open-ended, i.e., to mean including but not limited to.

The term computer program, as used above, may include software, firmware, and/or microcode, and may refer to programs, routines, functions, classes, and/or objects. The term shared, as used above, means that some or all code from multiple modules may be executed using a single (shared) processor.

Analytics is the discovery and communication of meaningful patterns in data. Especially valuable in areas rich with recorded information, analytics relies on the simultaneous application of statistics, computer programming and operations research to quantify performance.

The term “SROM” stands for smarter resource and operation management.

The term “REST” stands for representational state transfer.

The term “GUI” stands for graphical user interface.

“Spark” is an open source cluster computing framework.

“R” a programming language and software environment for statistical computing and graphics supported by the R Foundation for Statistical Computing.^{I}

“C++” is a general-purpose programming language.

“Python” is a widely used general-purpose, high-level programming language.

“ILOG CPLEX” is an optimization studio for development and deployment of optimization models, combining leading solver engines with a tightly integrated IDE and modeling language.

“SPSS” stands for Statistical Package for the Social Sciences, which is a software package used for statistical analysis.

“HDFS” stands for Hadoop Distributed File System, which is a distributed, scalable, and portable file-system written in Java for the Hadoop framework.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

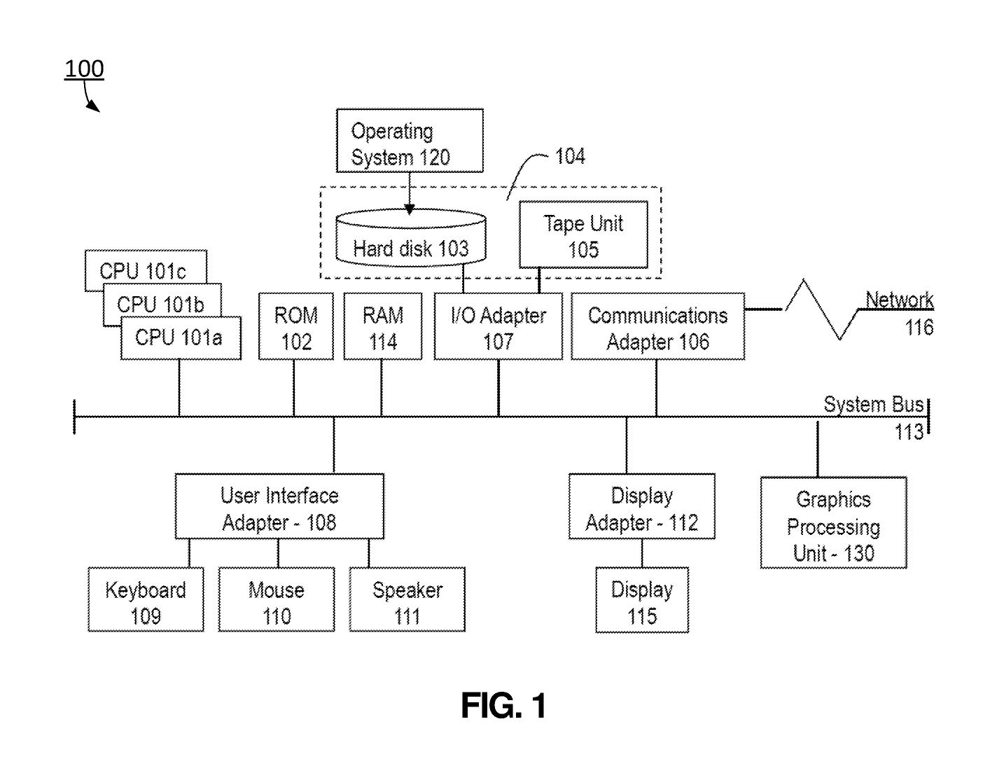

The present disclosure will now be described more fully hereinafter with reference to the accompanying drawings FIGS. 1-5, in which certain exemplary embodiments of the present disclosure are shown. The present disclosure may, however, be embodied in many different forms and should not be construed as limited to the embodiments set forth herein; rather, these embodiments are provided so that this disclosure will be thorough and complete, and will fully convey the scope of the disclosure to those skilled in the art.

Referring to FIG. 1, there is shown an embodiment of an analytics system 100 for implementing an ontology-guided analytics graphical user interface herein. In this embodiment, the analytics system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of the analytics system 100.

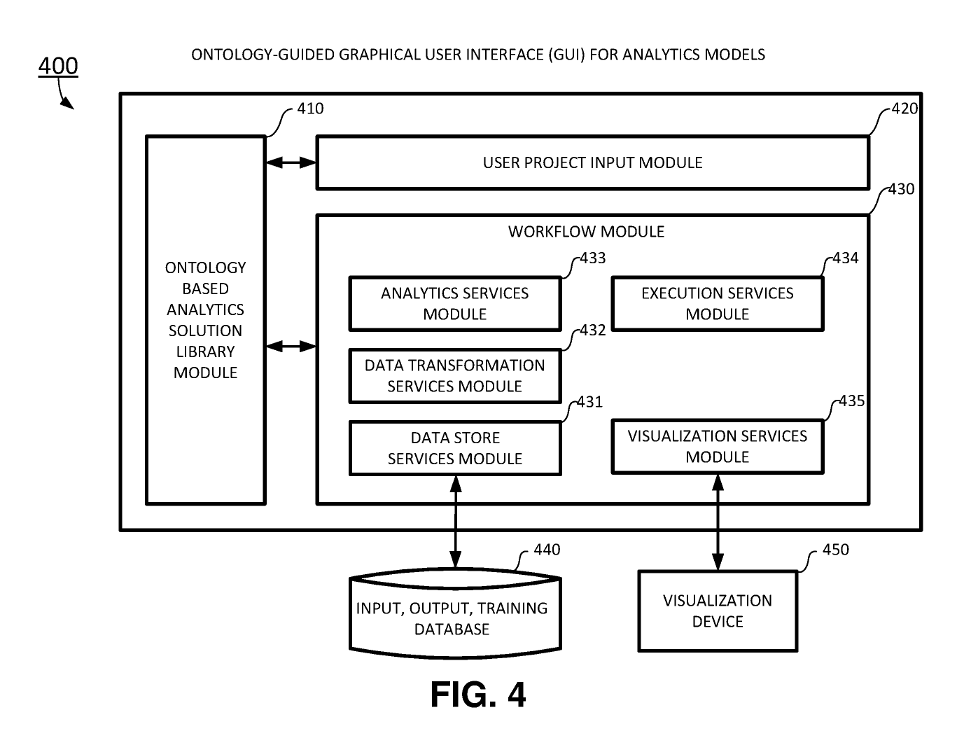

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the analytics system 100 may be stored in mass storage 104. A network adapter 106 interconnects bus 113 with an outside network 116 enabling the analytics system 100 to communicate with other such systems, for example, an external input, output, training database 440 as shown in FIG. 4. A screen (e.g., a display monitor) 115 is connected to system bus 113 by display adaptor 112, which may include a graphics adapter to improve the performance of graphics intensive applications and a video controller. The ontology-guided analytics graphical user interface of the analytics system 100 may be displayed on the screen 115. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the analytics system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the analytics system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1. In certain embodiments, the network 116 may include symmetric multiprocessing (SMP) bus, a Peripheral Component Interconnect (PCI) bus, local area network (LAN), wide area network (WAN), telecommunication network, wireless communication network, and the Internet.

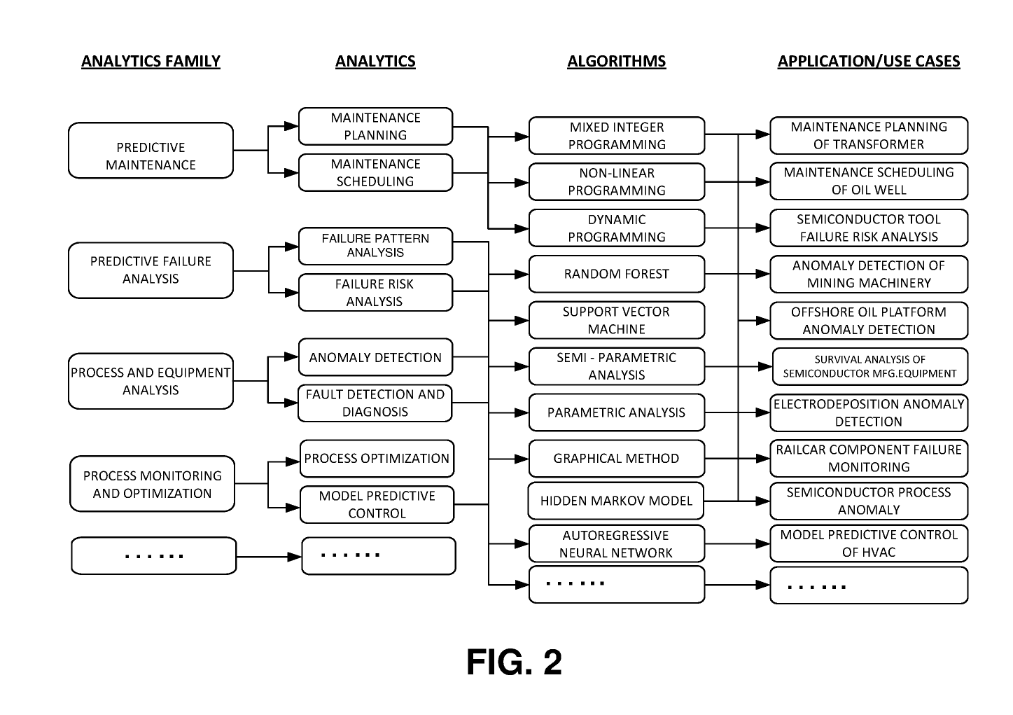

Referring now to FIG. 2, an exemplary ontology hierarchy of assets management for the ontology-guided graphical user interface for analytics models is shown according to certain embodiments of the present invention. In certain embodiments, the ontology hierarchy of assets management may include a set of analytics families. In one embodiment, the analytics families may include, as shown, Predictive Maintenance analytics family, Predictive Failure Analysis analytics family, Process and Equipment Analysis analytics family, Process Monitoring and Optimization analytics family, and etc.

Each of the set of analytics families may include a set of analytics. For example, the Predictive Maintenance analytics family may include Maintenance Planning analytics and Maintenance Scheduling analytics. The Predictive Failure Analysis analytics family may include Failure Pattern Analysis analytics, and Failure Risk Analysis analytics. The Process and Equipment Analysis analytics family may include Anomaly Detection analytics and Fault Detection and Diagnosis analytics. The Process Monitoring and Optimization analytics family may include Process Optimization analytics and Model Predictive Control analytics. There may be more analytics available for analytics families not listed here.

In certain embodiments, each of the analytics may include a set of algorithms. For example, each of the Maintenance Planning analytics and the Maintenance Scheduling analytics may include Mixed Integer Programming (MIP) algorithm, Non-Linear Programming (NLP) algorithm, and Dynamic Programming (DP) algorithm. Each of the Failure Pattern Analysis analytics, the Failure Risk Analysis analytics, the Anomaly Detection analytics, the Fault Detection and Diagnosis analytics, the Process Optimization analytics, and the Model Predictive Control analytics may include one or more algorithms such as: Random Forest algorithm, Support Vector Machine algorithm, Semi-Parametric Analysis algorithm, Parametric Analysis algorithm, Graphical Method algorithm, Hidden Markov Model algorithm, and Autoregressive Neural Network algorithm etc.

In certain embodiments, each of the algorithms may include a set of use cases. For example, each of the MIP algorithm, the NLP algorithm, the DP algorithm, the Random Forest algorithm, the Support Vector Machine algorithm, the Semi-Parametric Analysis algorithm, the Parametric Analysis algorithm, the Graphical Method algorithm, the Hidden Markov Model algorithm may include one or more use cases such as Maintenance Planning of Transformer, Maintenance Scheduling of Oil Well, Semiconductor Tool Failure Risk Analysis, Anomaly Detection of Mining Machinery, Offshore Oil Platform Anomaly Detection, Survival Analysis of Semiconductor Manufacturing Equipment, Electrodeposition Anomaly Detection, Railcar Component Failure Monitoring, and Semiconductor Process Anomaly Detection.

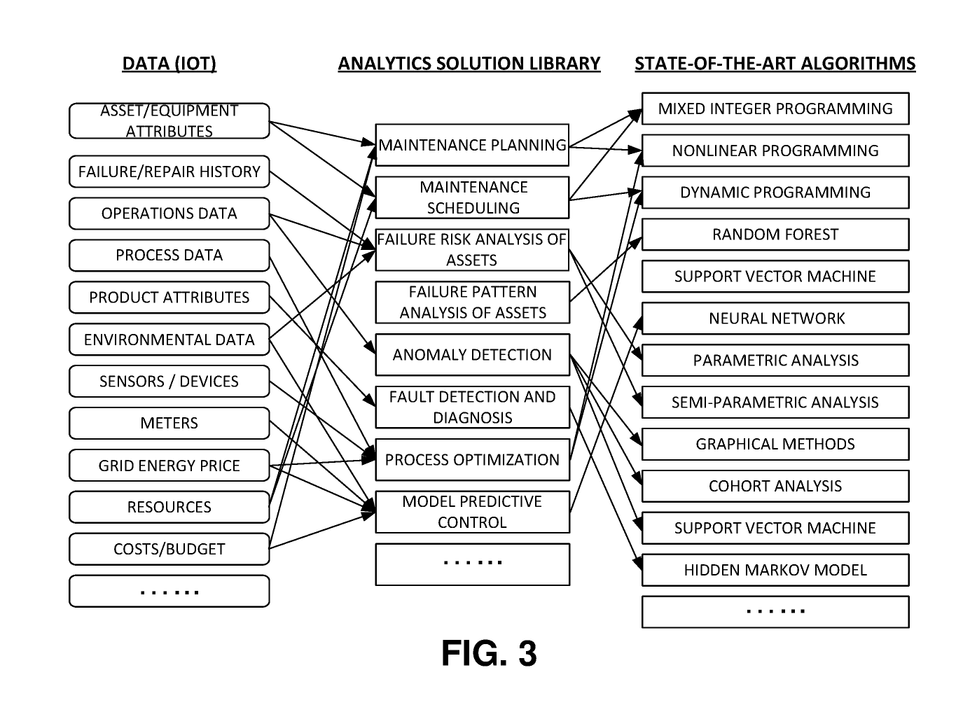

Referring new to FIG. 3, an exemplary smarter resource and operation management (SROM) industry solution library for the ontology-guided graphical user interface for analytics models is shown according to certain embodiments of the present invention. The ontology of SROM solution may include a variety of analytics views, algorithm views, use case views and relationship views. FIG. 3 shows a relationship view among the various input data, analytics solution library, and state-of-the-art algorithms. The input data may come from Internet of Things (IoT). The input data may include Asset and Equipment Attributes, Failure/Repair History, Operations Data, Process Data, Product Attributes, Environmental Data (e.g. weather), Sensors and Devices, Meters, Grid Energy Price, Resources, Costs and Budget etc.

In certain embodiments, the analytics solution library may include one or more of analytics such as: Maintenance Planning analytics, Maintenance Scheduling analytics, Failure Risk Analysis of Assets analytics, Failure Pattern Analysis of Assets analytics, Anomaly Detection analytics, Fault Detection and Diagnosis analytics, Process Optimization analytics, and Model Predictive Control analytics etc.

In certain embodiments, the state-of-the-art algorithms may include one or more algorithms such as MIP algorithm, the NLP algorithm, the DP algorithm, the Random Forest algorithm, the Support Vector Machine algorithm, Neural Network Algorithm, the Semi-Parametric Analysis algorithm, the Parametric Analysis algorithm, the Graphical Method algorithm, Cohort Analysis algorithm, the Hidden Markov Model algorithm etc.

Referring now to FIG. 4, a block diagram illustrating an exemplary ontology-guided graphical user interface 400 for analytics models is shown according to certain embodiments of the present invention. In certain embodiments, ontology-guided graphical user interface 400 for analytics models may include, among other things, an ontology-based analytics solution library module 410, a user project input module 420, and a workflow module 430.

In certain embodiments, the ontology-based analytics solution library module 410 may include a set of analytics families. For example, the set of analytics families may include: Predictive Maintenance Analytics Family, Predictive Failure Analysis Analytics Family, and Process Monitoring and Optimization Analytics Family, etc.

Each of the set of analytics families may include a set of analytics. For example, the predictive maintenance analytics family may include analytics such as maintenance planning analytics, and maintenance scheduling analytics. The predictive failure analysis analytics family may include failure pattern analysis analytics, and failure risk analysis analytics. A process and equipment analysis analytics family may include anomaly detection analytics.

Each of the set of analytics may include a set of algorithms. For example, the maintenance planning analytics of the predictive maintenance analytics family may include mathematical programming algorithm. The failure risk analysis analytics of the predictive failure analysis analytics family may include a parametric analysis algorithm. The anomaly detection analytics of the process and equipment analysis analytics family may include: graphical methods-outlier analysis algorithm, graphical methods-sliding window analysis algorithm, graphical methods-data set comparison algorithm, graphical methods-multiple comparison algorithm, hidden Markov method algorithm, ensemble method algorithm, and statistical learning algorithm.

Each of the set of algorithms may include a set of use cases. For example, the mathematical programming algorithm may include maintenance planning of transformer use case. The parametric analysis algorithm may include water main failure prediction use case, and railcar components failure risk monitoring use case. An autoregressive neural network based algorithm of the model predictive control of process analytics may include optimal control of HVAC system use case.

The analytics families, the analytics, the algorithms, and the use cases listed above are only a tiny fraction of the analytics families, the analytics, the algorithms, and the use cases available, and these listing are not meant to be exhaustive. Additional analytics families, analytics, algorithms, and use cases may be added to the ontology-based analytics solution library module 410 as these analytics families, analytics, algorithms, and use cases become available.

In certain embodiments, the user project input module 420 allows a user to define a project, or problem. The user uses the user project input module 420 to enter name, description, nature, and purpose of the project, to specify locations of input data and training data, to specify analytics model to use, to select display methods for input data, training data, intermediate data, results, and final solutions to the project, etc.

In certain embodiments, the workflow module 430 may include a Data Store Services Module 431, a Data Transformation Services Module 432, an Analytics Services Module 433, an Execution Services Module 434, and a Visualization Services Module 435.

The Data Store Services Module 431 may provide a uniform interface for storing input data and retrieving output data. Based on the analytics, the backing data store could be a local file system, a distributed file system like HDFS or a database like DB2/Cassandra. The Data Store Services Module 431 may be connected to an input, output and training database 440 to data exchanges.

The Data Transformation Services Module 432 may provide various schematic/structural transformations for input/output data. For example, if the user has data in csv format, and the algorithm accepts data in json (JavaScript Object Notation, a lightweight data-interchange format), there can be a service which transforms the data from csv to json format. This can be extended to provide other transformations.

The Analytics Services Module 433 may provide the implementation of the algorithm for a given analytics and use other services like the Data Store Services Module 431 and the Execution Services Module 434 to perform its action.

The Execution Services Module 434 may provide a generic execution environment for the algorithm. The Analytics Services Module 433 may use this service to execute the algorithm. Examples of the generic execution environment for the algorithm may include Spark, Matlab, R, C++, Python, ILOG Cplex etc.

The Visualization Services Module 435 may provide various visualizations (graphs, tables etc) for input and output data. The Visualization Services Module 435 may be specific to a particular input/output data format, and can be extended to add more GUI widgets. The Visualization Services Module 435 may be connected to other visualization device 450 for display on such device.

In certain embodiments, once the user defines the project, the user uses the ontology-guided graphical user interface 400 to select an analytics model. In one embodiment, the user selects an analytics family, an analytics, an algorithm and a use case. In another embodiment, the user selects only an analytics family and an analytics. For example, the user may click “Predictive Failure Analysis” in an Analytics Family view, “Failure Risk Analysis” in an Analytics view, “Semi-Parametric Analysis” in an Algorithm view, and “Failure Risk Analysis of Semiconductor” in a use case view. Then, the user may press “ESC” key to end the selection.

In one embodiment, once the analytics is selected, the workflow module 430 of the ontology-guided graphical user interface 400 may generate workflow of 9 steps as actionable widget (e.g. a clickable button on the ontology-guided graphical user interface 400 for analytics models). The workflows generated may include:

(1). Invoking the Data Store Services Module 431 and the Data Transformation Services Module 432 for uploading maintenance data file;

(2). Invoking the Data Store Services Module 431 and the Data Transformation Services Module 432 for uploading process history data;

(3). Invoking the Data Store Services Module 431 and the Data Transformation Services Module 432 for uploading process operations data;

(4). Invoking the Analytics Services Module 433 and the Execution Services Module 434 for prepare Cox Regression Table;

(5). Invoking the Analytics Services Module 433 using Semi-Parametric Risk Analysis Model and the Execution Services Module 434 using Matlab to compute and display Survival/Failure Function;

(6). Invoking the Visualization Services Module 435 for displaying Survival/Failure Function by Replacement Reason;

(7). Invoking the Visualization Services Module 435 using D3 graphic library for displaying Survival/Failure Function by Replacement Part Condition;

(8). Invoking the Analytics Services Module 433 using Feature selection algorithm and the Execution Services Module 434 using Statistical Package for the Social Sciences (SPSS) for Feature Selection for Cox-Regression; and

(9). Invoking the Analytics Services Module 433 using Semi-Parametric Risk Analysis Model and the Execution Services Module 434 using Matlab for Parametric Analysis.

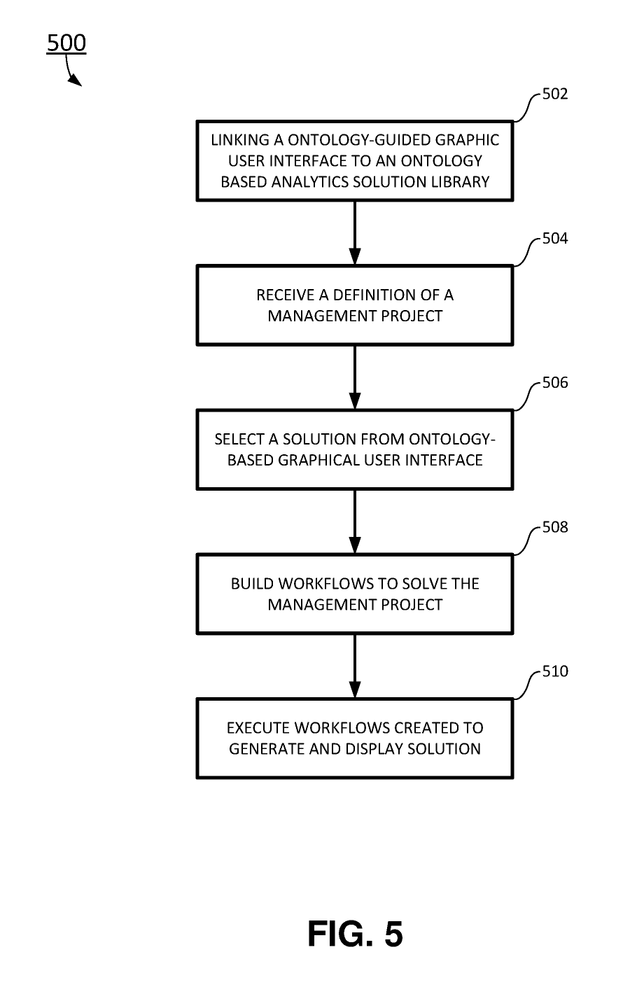

Referring now to FIG. 5, a flow chart of an exemplary method 500 of the ontology-guided graphical user interface for analytics models of the analytics system is shown according to certain embodiments of the present invention.

As shown at block 502, the ontology-guided graphical user interface 400 may link to a knowledge base. In certain embodiments, the knowledge base may be an ontology-based analytics solution library module 410. As described in earlier section, the ontology-based analytics solution library module 410 may include a hierarchy of analytics, formed in a shape of a tree. For example, the ontology-based analytics solution library module 410 may include many different analytics families. Each of the analytics families may include many different analytics. Each of the different analytics may include many different algorithms. Each of the algorithms may include many different use cases. The ontology-based analytics solution library module 410 is organized in such way that enables a user without specialized training in mathematical modeling to navigate through a collection of diverse analytics, develop, and use analytics to solve complex industrial problems in resource and operations management.

At block 504, the user uses the user project input module 420 of the ontology-guided graphical user interface 400 to define a project to be solved by the analytics system 100. In certain embodiments, the user uses the user project input module 420 to enter name, description, nature, and purpose of the project, to specify locations of input data and training data, to specify analytics model to use, to select display methods for input data, training data, intermediate data, results, and final solutions to the project.

At block 506, the user uses the user project input module 420 of the ontology-guided graphical user interface 400 to select a solution to the project. In certain embodiments, the user uses the ontology-guided graphical user interface 400 to select an analytics model. For example, the user may click “Process and Equipment Analysis” in an Analytics Family view, “Anomaly Detection” in an Analytics view, “Graphical Method” using Outlier Analysis algorithm in an Algorithm view, and “Mining Machinery” in a use case view. Then, the user may press “ESC” key to end the selection.

At block 508, the workflow module 430 may then generate workflows based on the selection in block 506. In one embodiment, the workflow module 430 may then generate workflow of 5 Steps as actionable widgets (e.g., clickable buttons etc.) The actionable widgets may include:

(1). Invoking the Data Store Services Module 431 and the Data Transformation Services Module 432 for uploading training data file;

(2). Invoking the Analytics Services Module 433 using graphical method algorithm to build Detection Model;

(3). Invoking the Data Store Services Module 431 and the Data Transformation Services Module 432 for uploading local validation data file;

(4). Invoking the Analytics Services Module 433 and the Execution Services Module 434 using R/Python to validate the models, and invoking the Visualization Services such as D3 graphic library to view Anomaly & Dependency Graph; and

(5). Invoking the Execution Services Module 434 using R/Python to calculate Prediction Accuracy, and invoking the Visualization Services such as D3 graphic library to set threshold.

At block 510, the workflow module 430 may execute the workflows generated in the block 508. In certain embodiments, the executing may include a representational state transfer (REST)-based wrapper service. In exemplary embodiments, the REST-based wrapper service may include: providing a uniform interface for storing input data and retrieving output data via the Data Store Services Module 431, providing a generic execution environment for the algorithm selected via the Execution Services Module 434, implementing the algorithm selected via the Analytics services module 433, providing a variety of visualizations for input and output data on a visualization device via the Visualization Services Module 435, and providing a variety of schematic and structural transformations for input data and output data via the Data Transformation Services Module 432.

In another embodiment of the present invention, an analytics system may include a computer. The computer may include a processor to operate an ontology-guided graphical user interface for analytics models, and a memory storing computer executable instructions for the ontology-guided graphical user interface for analytics models of the analytics system. When the computer executable instructions are executed at the processor, the computer executable instructions cause the analytics system to perform: linking the ontology-guided graphical user interface for analytics models to an ontology based analytics solution library, receiving a definition of a management project to be solved by the analytics system from a user via the ontology-guided graphical user interface for analytics models, selecting, by the user via the ontology-guided graphical user interface for analytics models, a solution from the ontology based analytics solution library according to the management project, building one or more workflows to solve the management project, and executing the workflows to generate solution to the management project.

In yet another embodiment of the present invention, the present disclosure relates to a non-transitory computer storage medium. In certain embodiments, the non-transitory computer storage medium stores computer executable instructions. When these computer executable instructions are executed by a processor of an analytics system having an ontology-guided graphical user interface for analytics models, these computer executable instructions cause the analytics system to perform: linking the ontology-guided graphical user interface for analytics models to an ontology based analytics solution library, receiving a definition of a management project to be solved by the analytics system from a user via the ontology-guided graphical user interface for analytics models, selecting, by the user via the ontology-guided graphical user interface for analytics models, a solution from the ontology based analytics solution library according to the management project, building one or more workflows to solve the management project, and executing the workflows to generate solution to the management project.

The present invention may be a computer system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for an ontology-guided graphical user interface to an ontology based analytics solution library comprising:
associating the ontology-guided graphical user interface with the ontology based analytics solution library having one or more analytics families, each of the one or more analytics families comprising one or more analytics, each of the one or more analytics comprising one or more algorithms, and each of the one or more algorithms comprising one or more use cases, wherein the ontology based analytics solution library is configured to collect input data, perform analysis of the input data using the one or more algorithms, generate one or more solutions based on the results of the analysis of the input data, and store the one or more solutions generated in the analytics solution library;
receiving a definition of an asset management problem to be solved using the ontology based analytics solution library from a user via the ontology-guided graphical user interface;
navigating, by the user via the ontology-guided graphical user interface, through the one or more analytics families, the one or more analytics, the one or more algorithms, and the one or more use cases, to locate one or more solutions from the ontology based analytics solution library according to the definition of the asset management problem;
building one or more workflows to solve the asset management problem according to the one or more solutions located; and
executing the one or more workflows to solve the asset management problem; wherein the navigating comprises:
selecting an analytics family from the one or more analytics families according to the definition of the asset management problem;
selecting an analytics from the analytics family selected according to the definition of the asset management problem;
selecting an algorithm from the analytics selected according to the definition of the asset management problem; and
selecting a use case from the algorithm selected according to the definition of the asset management problem.

2. The method of claim 1, wherein the asset management problem comprises:
one or more predictive maintenance problems including maintenance planning of certain equipment, and maintenance scheduling of buildings or assets;
one or more predictive failure analysis problems including equipment failure risk analysis, and anomaly detection of certain assets;
one or more process and equipment analysis problems including survival analysis of manufacturing equipment, and electrodeposition anomaly detection; and
one or more process monitoring and optimization problems including certain equipment failure monitoring, and model predicative control of industrial tools.

3. (canceled)

4. The method of claim 1, wherein the ontology-guided graphical user interface comprises at least an analytics family view, an analytics view, an algorithm view, a use case view and a relationship view.

5. The method of claim 1, wherein the building one or more workflows comprises generating the one or more workflows for the analytics selected as an actionable widget.

6. The method of claim 1, wherein the executing comprises:
providing a uniform interface for storing the input data and retrieving output data via a data store services module;
providing a generic execution environment for the algorithm selected via an execution services module;
implementing the algorithm selected via an analytics services module;
providing one or more visualizations for the input data and the output data on a visualization device via a visualization services module; and
providing one or more schematic and structural transformations for the input data and the output data via a data transformation services module.

7. The method of claim 1, wherein the executing comprises a representational state transfer (REST)-based wrapper service.

8. An analytics system comprising:
a processor configured to operate the analytics system having an ontology-guided graphical user interface and an ontology based analytics solution library having one or more analytics families, each of the one or more analytics families comprising one or more analytics, each of the one or more analytics comprising one or more algorithms, and each of the one or more algorithms comprising one or more use cases, wherein the ontology based analytics solution library is configured to collect input data, perform analysis of the input data using the one or more algorithms, generate one or more solutions based on the results of the analysis of the input data, and store the one or more solutions generated in the ontology based analytics solution library;
a uniform interface for storing the input data and retrieving output data via a data store services module;
an execution services module for generating a generic execution environment for an algorithm selected from the one or more algorithms according to a definition of an asset management problem to be solved by the analytics system from a user via the ontology-guided graphical user interface;
an analytics services module for implementing the algorithm selected;
a visualization device for one or more visualizations for the input data and the output data via a visualization services module;
a data transformation services module for generating one or more schematic and structural transformations for the input data and the output data; and
a memory storing computer executable instructions which, when executed at the processor of the analytics system, cause the processor to perform:
associating the ontology-guided graphical user interface with the ontology based analytics solution library;
navigating, by the user via the ontology-guided graphical user interface, through the one or more analytics families, the one or more analytics, the one or more algorithms, and the one or more use cases, to locate one or more from the ontology based analytics solution library according to the definition of the asset management problem;
building one or more workflows to solve the asset management problem according to the one or more solutions located; and
executing the one or more workflows to solve the asset management problem; wherein the navigating comprises:
selecting an analytics family from the one or more analytics families according to the definition of the asset management problem;
selecting an analytics from the analytics family selected according to the definition of the asset management problem;
selecting an algorithm from the analytics selected according to the definition of the asset management problem; and
selecting a use case from the algorithm selected according to the definition of the asset management problem.

9. The analytics system of claim 8, wherein the asset management problem comprises:
one or more predictive maintenance problems including maintenance planning of certain equipment, and maintenance scheduling of buildings or assets;
one or more predictive failure analysis problems including equipment failure risk analysis, and anomaly detection of certain assets;
one or more process and equipment analysis problems including survival analysis of manufacturing equipment, and electrodeposition anomaly detection; and
one or more process monitoring and optimization problems including certain equipment failure monitoring, and model predicative control of industrial tools.

10. (canceled)

11. The analytics system of claim 8, wherein the ontology-guided graphical user interface comprises at least an analytics family view, an analytics view, an algorithm view, a use case view and a relationship view.

12. The analytics system of claim 8, wherein the building comprises generating the one or more workflows for the analytics selected as an actionable widget.

13. (canceled)

14. The analytics system of claim 10, wherein the executing comprises a representational state transfer (REST)-based wrapper service.

15. A non-transitory computer storage medium having computer executable instructions stored thereon which, when executed by a processor of an analytics system, cause the processor to perform:
associating an ontology-guided graphical user interface with an ontology based analytics solution library having one or more analytics families, each of the one or more analytics families comprising one or more analytics, each of the one or more analytics comprising one or more algorithms, and each of the one or more algorithms comprising one or more use cases, wherein the ontology based analytics solution library is configured to collect input data, perform analysis of the input data using the one or more algorithms, generate one or more solutions based on the results of the analysis of the input data, and store the one or more solutions generated in the ontology based analytics solution library;
receiving a definition of an asset management problem to be solved by the analytics system from a user via the ontology-guided graphical user interface;
navigating, by the user via the ontology-guided graphical user interface, through the one or more analytics families, the one or more analytics, the one or more algorithms, and the one or more use cases, to locate one or more solutions from the ontology based analytics solution library according to the definition of the asset management problem;
building one or more workflows to solve the asset management problem according to the one or more solutions located; and
executing the one or more workflows to solve the asset management problem; wherein the navigating comprises:
selecting an analytics family from the one or more analytics families according to the definition of the asset management problem;
selecting an analytics from the analytics family selected according to the definition of the asset management problem;
selecting an algorithm from the analytics selected according to the definition of the asset management problem; and
selecting a use case from the algorithm selected according to the definition of the asset management problem.

16. The non-transitory computer storage medium of claim 15, wherein the asset management problem comprises:
one or more predictive maintenance problems including maintenance planning of certain equipment, and maintenance scheduling of buildings or assets;
one or more predictive failure analysis problems including equipment failure risk analysis, and anomaly detection of certain assets;
one or more process and equipment analysis problems including survival analysis of manufacturing equipment, and electrodeposition anomaly detection; and
one or more process monitoring and optimization problems including certain equipment failure monitoring, and model predicative control of industrial tools.

17. (canceled)

18. The non-transitory computer storage medium of claim 15, wherein the ontology-guided graphical user interface comprises at least an analytics family view, an analytics view, an algorithm view, a use case view and a relationship view.

19. The non-transitory computer storage medium of claim 15, wherein the building comprises generating the one or more workflows for the analytics selected as an actionable widget.

20. The non-transitory computer storage medium of claim 15, wherein the executing comprises a representational state transfer (REST)-based wrapper service including:
providing a uniform interface for storing the input data and retrieving output data via a data store services module;
providing a generic execution environment for the algorithm selected via an execution services module;
implementing the algorithm selected via an analytics services module;
providing one or more visualizations for the input data and the output data on a visualization device via a visualization services module; and
providing one or more schematic and structural transformations for the input data and the output data via a data transformation services module.
